(19) United States
(12) Patent Application Publication
(10) Pub. No.: US 2025/0309742 A1
(43) Pub. Date: Oct. 2, 2025

(54) LINEAR MOTOR WITH CAPACITIVE POWER TRANSFER

(71) Applicant: B&R Industrial Automation GmbH, Eggelsberg (AT)

(72) Inventor: Michael Reinthaler, Pfaffstätt (AT)

(21) Appl. No.: 18/986,886

(22) Filed: Dec. 19, 2024

(30) Foreign Application Priority Data
Mar. 29, 2024 (EP) 24167870.5

(51) Int. Cl. H02K 41/03; H02J 50/05; H02J 50/80; H02K 1/12

(52) U.S. Cl. CPC H02K 41/031; H02J 50/05; H02J 50/80; H02K 1/12; H02K 2201/03

(57) ABSTRACT

Disclosed is a linear motor with improved capacitive power transfer from the stator to the shuttle of the motor. The linear motor comprises a capacitive power transfer arrangement with a power transfer capacitor with a power transfer air gap as dielectric in between a primary electrode and a secondary electrode, wherein the motor air gap of the linear motor and the power transfer air gap are parallel and are arranged in transverse direction next to each other.

### CROSS-REFERENCE TO RELATED APPLICATIONS

The present application claims priority to European Patent Application No. 24167870.5 filed on Mar. 29, 2024, and titled “LINEAR MOTOR WITH CAPACITIVE POWER TRANSFER”, which is hereby incorporated by reference in its entirety.

### TECHNICAL FIELD

The present disclosure pertains to a linear motor having a stator and at least one shuttle movable along the stator in a direction of movement, wherein drive magnets are arranged along the stator in direction of movement and a number of drive coils are arranged on the at least one shuttle or drive magnets are arranged on the shuttle and a number of drive coils are arranged along the stator in direction of movement, wherein the drive magnets and the number of drive coils face each other and are separated in a normal direction by a linear motor air gap with a motor air gap distance in a normal direction, wherein the linear motor air gap extends in direction of movement and in a transverse direction that is normal on the direction of movement and the normal direction, wherein a capacitive power transfer arrangement is provided in the linear motor, the capacitive power transfer arrangement comprising at least one primary electrode arranged on the stator and extending in direction of movement and further comprising a secondary electrode arranged on the shuttle, the at least one secondary electrode facing the primary electrode and being arranged in normal direction opposite the primary electrode, wherein the primary electrode and the secondary electrode are separated by a power transfer air gap with a power transfer air gap distance in normal direction, wherein the power transfer air gap extends in direction of movement and in transverse direction, and wherein the at least one primary electrode and the at least one secondary electrode form a power transfer capacitor with the power transfer air gap as dielectric for capacitive power transfer for transferring electrical energy from the stator to the shuttle.

### BACKGROUND

Long stator linear motors (LLM) are well-known transport devices. In an LLM, drive coils are arranged stationary along a stator that may extend along a long track. On a moving shuttle of the LLM, drive magnets are arranged. In operation of the LLM, the drive coils are energized by applying a drive coil voltage to the drive coils for generating an electromagnetic drive field. This electromagnetic drive field interacts with the magnetic field of the drive magnets on the shuttle for producing a propulsion force acting on the shuttle. Said propulsion forces moves the shuttle along the stator of the LLM. Examples of LLM are given in WO 2013/143783 A1, U.S. Pat. No. 6,876, 107 B2 or US 2013/0074724 A1. In addition to a propulsion force, a force transverse to the direction of movement may also be produced by the interaction of the electromagnetic drive field and the magnetic field of the drive magnets. Such a transverse force may be used to guide a shuttle in an electromagnetic switch of the track in the desired direction. This known from EP 3109998 B1, for example.

One of the advantages of an LLM is that the shuttle when using permanent magnets as drive magnets does not need electric energy for producing the magnetic field. A major disadvantage is however the rather complex stator with the drive coils that need to be controlled individually. Apart from that, the drive coils produce quite some heat that is conducted into the stator which may require active cooling. Such active cooling increases the complexity of the stator further. Last but not least, for efficient operation of the LLM, a small air gap between the drive coils and the drive magnets is required. But the smaller the air gap the higher the risk that parts of the shuttle get into contact with parts of the stator. Thermal expansion of the stator may even aggravate this problem. Mechanical contact between stator and shuttle is highly undesired because this can cause severe damage to the stator and/or the shuttle and can even lead to shutdown of the LLM.

At least some of these problems do not occur in a different linear motor design called short stator linear motor (SLM). In a SLM, the drive coils are arranged on the shuttle and the drive magnets in the stator. The stator design is therefore significantly simplified a compared to an LLM. The SLM motor design, however, requires electrical energy on the shuttle for driving the drive coils. Therefore, in a SLM, transfer of electrical energy to the moving shuttle is required. This can be done using wiper contacts. Wiper contacts are however prone to failure and require regular maintenance. Therefore, contactless power transfer is desired. Contactless power transfer can be inductive or capacitive.

There are however also LLM applications in which electric power transfer to the shuttle is required. This can be the case, for example, when the shuttle comprises actuators, like grippers, hydraulic or pneumatic pumps, that need electric energization for their operation. Also in such LLM applications, contactless power transfer is desired and contactless power transfer can be inductive or capacitive. A shuttle of a SLM could also comprise electric components that need to be energized with electric energy.

Inductive or capacitive power transfer is used, for example, for charging applications, like charging a mobile device or an electrified car. An example for capacitive charging is given in Regensburger B., et al., “High-Performance Capacitive Wireless Power Transfer System for Electric Vehicle Charging with Enhanced Coupling Plate Design”, Proceedings Energy Conversion Congress and Exposition (ECCE), 2018 IEEE, p.2472-2477.

It is also known, that an inductive or conductive power transfer arrangement can simultaneously be used for data transmission to or from the shuttle. Such data transmission could be required in an SLM in order to send control commands for energizing the drive coils on the shuttle, or in an LLM to send control commands for an actuator on the shuttle. The shuttle of an LLM or SLM could send measuring data or process parameters or data to the motor control unit. Therefore, bidirectional data transfer using an inductive or conductive power transfer arrangement is highly advantageous transport applications using linear motors. An example for this is given in Shaoge Zang, et al., “Capacitive Power Transfer System With Integrated Wide Bandwidth Communication”, IEEE Transactions on Power Electronics, Vol. 37, Issue 8, August 2022, p.8805 8810.

WO 2020/188430 A1 shows an inductive power transfer in a LLM transport system. This inductive power transfer could however also be applied in a SLM. The contactless inductive power transfer exploits the principle of magnetic induction to transfer electric energy to the shuttle by means of inductively coupled transmitting and receiving coils. A major disadvantage of an inductive power transfer is the need of transmitting and receiving coils along the track on which power transfer is needed. These coils need space and will generate significant heat during operation with similar disadvantages as mentioned above.

Capacitive power transfer is also known for linear motors. EP 2 793 356 B1 and EP 2 903 407 A1 describe capacitive power transfer for a SLM. To this end a first electrode is arranged on the shuttle and a second electrode, separated by an air gap from the first electrode, on the stator. The two electrodes form a capacitor with the air in between as dielectric that is used for power transfer. In EP 2 793 356 B1 the drive coil is arranged behind the electrode for power transfer. This increases the air gap for the electromagnetic drive field and, hence, decreases the possible propulsion force. For higher propulsion forces, significantly higher coil voltages were required. In EP 2 903 407 A1, the drive coils are offset 90° from the electrodes for power transfer which allow optimum air gaps between drive coils and drive magnets as well as between the two electrodes for capacitive power transfer.

But in both cases EP 2 793 356 B1 and EP 2 903 407 A1 the SLM has just a very simply track in the form a short straight track. Such a simple track is usually sufficient for a drive axis or a working machine as in EP 2 793 356 B1 and EP 2 903 407 A1. In a transport device, however, the track along which the shuttle may move usually has a much more complex shape with straight sections, bends (of different curvatures), inclinations and often also with switches connecting different tracks of the transport system. For such tracks, especially for bends, the design of the capacitive power transfer as described in EP 2 903 407 A1 is not suitable. With a 90° offset between the drive coils and the electrodes for power transfer, either the air gap between the drive coils and the drive magnets or the air gap between the electrodes for power transfer changes in a bend of the motor track due to the curvature in the bend. So, either the capacitive power transfer or the drive of the shuttle would suffer in a bend of the motor track and would not operate efficiently. Compensation of these effects would require higher electrical energies for the capacitive power transfer or the drive which would increase losses and heat generation.

### BRIEF DESCRIPTION

It is an object of the present disclosure to provide a linear motor (LLM or SLM) with improved capacitive power transfer from the stator to the shuttle of the motor. This object is achieved with a linear motor according to claim 1.

By arranging the primary and secondary electrodes such that the power transfer air gap in between is oriented to be parallel to the motor air gap it is ensured that the air gaps are not affected when the stator is bent in one direction, or that the air gaps are equally affected when the stator is bent in another direction. This allows a linear motor with complex geometry, especially with bended sections, without negative effects on the efficiency of the power transfer (and/or the capacitive data communication).

The power transfer capacitor formed by a primary electrode and a secondary electrode coupled thereto may additionally be used for capacitive data communication. Or more than one capacitor is provided so that at least one capacitor is used for power transfer and another one for data communication.

When more than one power transfer capacitor is provided, the electric energy that can be transferred to shuttle may be increased.

### BRIEF DESCRIPTION OF DRAWINGS

The present disclosure is described below in greater detail with reference to

FIGS. 1 to 5 which show schematic and non-limiting advantageous embodiments of the present disclosure by way of example. In the drawings:

FIG. 1 shows a closed short-stator linear motor stator track with capacitive power transfer;

FIG. 2 a cross section through the stator and a shuttle on the stator;

FIG. 3 a section of a long-stator linear motor stator track with capacitive power transfer; and

FIG. 4 and FIG. 5 different concepts of capacitive power transfer.

### DETAILED DESCRIPTION

In the following linear motor refers to both motor concept, i.e. to long-stator linear motors (LLM) and to short-stator liner motors (SLM).

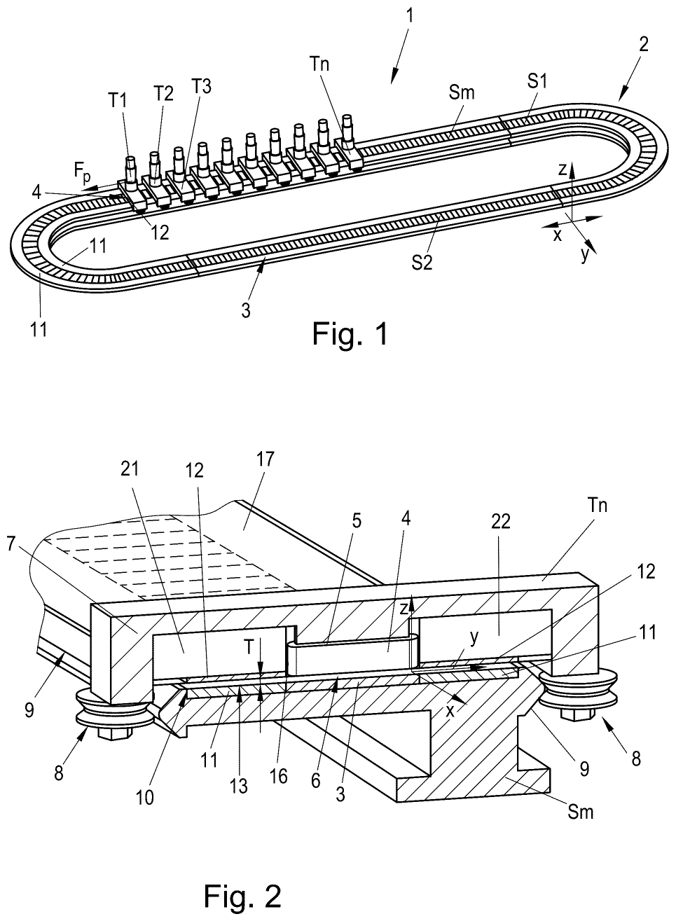

FIG. 1 shows a short stator linear motor (SLM) as example of a linear motor 1. The linear motor 1 has a stator 2 and at least one shuttle Tn that is movable along the stator 2. “n” is used as index to be able to distinguish different shuttles, if need be, whereas Tn is used in the following when no specific shuttle is addressed. The stator 2 is stationary and the shuttle Tn moves with respect to the stator 2.

The stator 2 of the linear motor 1 may have any shape and geometry. The stator 2 may comprise straight track sections and bend track sections, possibly also bends in different directions. In the example of FIG. 1, the stator 2 is designed as closed circuit extending 2-dimensionally in plane with two 180° bends connected by straight track sections. It is however not necessary that the stator 2 extends in a plane but could also extend 3-dimensionally which would require bends in different directions. The stator 2 may also comprise a number of stator segments Sm. “m” is used as index to be able to distinguish different stator segments, if need be, whereas Sm is used in the following when no specific stator segment is addressed. Each stator segment Sm may have a given shape and geometry, like a bend with a certain curvature or bend length, a straight line, a switch etc. Stator segments Sm are arranged next to each other in direction of movement x of a shuttle Tn along the stator 2 in order to form the desired stator 2 for a given application.

The track of the stator 2 defines a direction of movement x. A shuttle Tn, when driven, may move along the stator 2 in the direction of movement x.

For driving a shuttle Tn of a SLM, drive magnets 3, usually permanent magnets or electromagnets, are arranged along the stator 2 (as in FIG. 1 and FIG. 2). A number of drive coils 4 are arranged on the shuttle Tn. Usually more than one drive coil 4 is provided. When energized with a drive coil voltage, the number of drive coils 4 produce an electromagnetic drive field. This electromagnetic drive field interacts with the magnetic field of the drive magnets 3 in the region of the shuttle Tn for producing a propulsion force Fₚ that moves the shuttle Tn in the desired direction of movement x along the stator 2.

In well-known manner, by controlling the propulsion force Fₚ the kinematic quantities (position, speed, acceleration, jerk) of the movement of the shuttle Tn along the stator 2 may be controlled. It is also possible to control the movement of each shuttle Tn on the stator 2 independently. The propulsion force Fₚ is controlled by controlling the energization of the drive coils 4.

FIG. 2 shows a cross section through a shuttle Tn of a SLM on the stator 2. In this embodiment, the number of drive coils 4 of the shuttle Tn are arranged on a laminated core 5 made of magnetically highly conductive material, like an iron-based material. Each one of the number of drive coils 4 is arranged on a tooth of the laminated core 5, for example. The number of drive coils 4 and the drive magnets 3 on the stator 2 face each other. The number of drive coils 4 is arranged opposite (in direction z) to the drive magnets 3 on the stator with a motor air gap 6 in between. The motor air gap 6 is the air space between the drive coils 4 and the drive magnets 3.

The motor air gap 6 extends two-dimensionally in direction of movement x in a transverse direction y, whereas the transverse direction y is basically defined by the surface of the stator 2 facing the shuttle Tn. The direction of movement x and the transverse direction y span a movement plane of the SLM along which the shuttle Tn is moved. In a direction z, normal on the direction of movement x and transverse direction y, the motor air gap 6 has an air gap distance L. This gap distance L is decisive for the efficiency of the linear motor 1. For an efficient operation of the SLM, the air gap distance L is to be as small as possible, as this increases the electromagnetic field strength in the motor air gap 6.

In FIG. 2 it is also shown, that the shuttle Tn comprises a shuttle body 7, onto which the drive coils 4, and possibly also the laminated core 5, are arranged. The shuttle body 7 is usually made of a magnetically non-conductive material, or at least a material having a very low magnetically conductance. It is further shown, that the drive coils 4 can be covered by a drive coil cover 16 for protecting the drive coils 4. Also the drive magnets 3 on the stator 2 are usually covered by a magnet cover 17 for protecting the drive magnets 3.

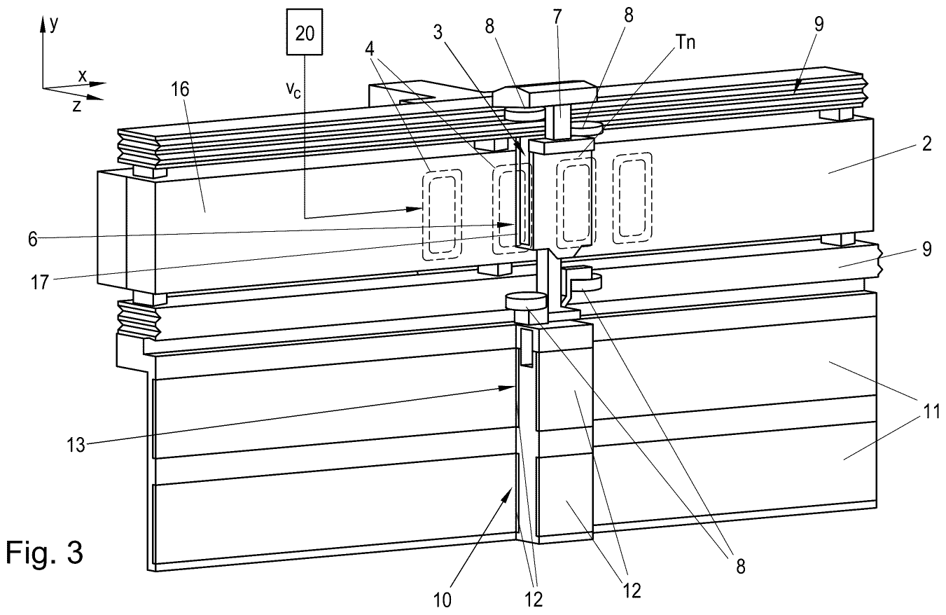

In FIG. 3 a section of the track of linear motor 1 in the form of an LLM is shown. In case of an LLM, the drive coils 4 are arranged on the stator 2 in direction of movement x next to each other. The drive magnets 3 are arranged on the shuttle Tn and opposite (in direction z) the drive coils 4. In the embodiment of FIG. 3, the drive coils 4 are covered by a drive coil cover 16 and the drive magnets 3 are covered by a magnet cover 17. As in case of a SLM, the drive coils 4 in the region of the shuttle Tn are energized with a drive coil voltage v_{c} for producing an electromagnetic field that interacts with the magnetic field of the drive magnets 3 for producing a propulsive force acting on the shuttle Tn for moving the shuttle Tn along the stator 2.

Although not clearly seen in FIG. 3, also in case of an LLM, a motor air gap 6 is provided between the drive coils 4 (facing the motor air gap 6) and the drive magnets 3 (facing the motor air gap 6) as described above with respect to the SLM of FIG. 2. The motor air gap 6 has an air gap distance L in direction z.

In the embodiment of FIG. 3, there are two primary electrodes 11 arranged on the stator 2 with both primary electrodes 11 on one side (as seen in transverse direction) of the stator 2. Therefore, also the associated secondary electrodes 12 on the shuttle Tn are on one side of the drive magnets 3. It would however also be possible to provide at least one primary electrode 11 on each side (as seen in transverse direction) of the on the stator 2. In this case, also at least one associated secondary electrode 12 on the shuttle Tn were on each side of the drive magnets 3.

Usually, the shuttle Tn comprises also guide means 8 used for guiding the shuttle Tn along the stator 2. To this end, also the stator 2 comprises guide means 9 and the shuttle guide means 8 interact with the stator guide means 9 for guiding the shuttle Tn. In the embodiments of the linear motor 1 of FIG. 2 and FIG. 3, the shuttle guide means 8 are rollers that are rotatably arranged on the shuttle Tn, specifically on the shuttle body 7, and the stator guide means 9 is formed by guide rails on which the rollers roll during operation of the SLM.

In FIG. 3 it is also indicated that the linear motor 1 is also provided with a motor control unit 20 that controls energization of the drive coils 4 with the drive coil voltage v_{c} in order to move the shuttle Tn in the desired way (e.g. speed, acceleration). Although obvious and well-known, it is to mention that the drive coil voltages v_{c} of different drive coils 4 are not necessarily equal, but are usually different. The motor control unit 20 is usually a microprocessor-based hardware on which control software is run.

For providing the shuttle Tn of the linear motor 1 with electric energy, for example required for energizing the drive coils 4 and for producing the electromagnetic drive field (SLM) or required for energizing electric components on the shuttle Tn (LLM or SLM), the linear motor 1 is provided with a capacitive power transfer (CPT) arrangement 10 for transferring electrical energy from the stator 2 to the shuttle Tn.

The CPT arrangement 10 (as shown in FIGS. 2 and 3) comprises at least one primary electrode 11 arranged on at least a section of the stator 2. The primary electrode 11 extends in direction of movement x along the stator 2 in direction of movement x. In some embodiments, the length of the primary electrode 11 in direction of movement x is longer than the length of the shuttle Tn in direction of movement x, usually much longer than the length of the shuttle Tn in direction of movement x. In some embodiments, the primary electrode 11 extends along the complete length of the stator 2 of the linear motor. The primary electrode 11 is at least arranged in a section of the stator 2 on which electric power transfer to the shuttle Tn is required. On the shuttle Tn, at least one secondary electrode 12 is arranged. The primary electrode 11 and the secondary electrode 12 are arranged opposite to each other (in direction z) and face each other, so that a power transfer air gap 13 is formed between the primary electrode 11 and the secondary electrode 12. Like, the motor air gap 6, also the power transfer air gap 13 is the air space between the at least one primary electrode 11 and the opposite secondary electrode 12 and extends two-dimensionally in direction of movement x and transverse direction y. In direction z, the power transfer air gap 13 has an air gap distance T (only shown in FIG. 2). For efficient power transfer, the air gap distance T of the power transfer air gap 13 is to be as small as possible in normal direction z. In some embodiments, the air gap distance L of the motor air gap 6 and the air gap distance T of the power transfer air gap 13 are equal.

According to the present disclosure, the motor air gap 6 and the power transfer air gap 13 are provided next to each other in transverse direction y, that is normal to the direction of movement x of the shuttle Tn along the stator 2 and normal to the normal direction z in which direction the motor air gap distance L and the power transfer air gap distance T are given. The motor air gap 6 and the power transfer air gap 13 are separated and hence do not overlap and are parallel to each other.

“Parallel” means that the motor air gap 6 and the power transfer air gap 13 are at least line parallel in a cross section normal to the direction of movement x, i.e. in a y-z plane (as shown in FIG. 2 for example). On a straight section of the stator 2, the whole motor air gap 6 and power transfer air gap 13 extending also in direction of movement x would be parallel. On a bend section of the stator 2, the direction of movement x is of course the tangent on the curvature of the bend. In this case the motor air gap 6 and the power transfer air gap 13 vary in direction of movement x because of the bend and the motor air gap 6 and the power transfer air gap 13 are parallel in each cross section normal to the direction of movement x.

The advantage of the arrangement of the primary electrode 11 and the secondary electrode 12 next to the short stator motor air gap 6 in transverse direction y is that bending the stator 2 around the normal direction z or around the direction of movement x does not affect the motor air gap 6 and the power transfer air gap 13. The motor air gap distance L and the power transfer air gap distance T would remain unchanged when the stator 2 were bend around the normal direction z (as in FIG. 1) or around the direction of movement x. As the air gaps 6, 13 are not affected, also the motor drive and the power transfer are not affected.

When the stator 2 were bent around the transverse direction y, both air gaps 6, 13 were affect because the distance between the shuttle Tn and the stator 2 would change due to the curvature of the bend and due to the length of the shuttle Tn in direction of movement x. But air gaps 6, 13 would be affected equally which simplified compensation of a change in the air gap 6, 13 in order to avoid that the generation of the propulsion forces Fₚ or the power transfer is negatively affected.

In case of a bend of the stator 2 around the transverse direction y the guide of the shuttle Tn (shuttle guide means 8 and/or stator guide means 9) could be adapted in the region of the bend so that the resulting average air gap distance L, T when the shuttle Tn travels along the bend is equal to the air gap distance L, T on a straight section of the stator 2. This would compensate the effects of the changed air gaps 6, 13 on the drive or power transfer of a shuttle Tn when the shuttle Tn travels through such a bend.

A bend of the stator 2 around the transverse direction y could however advantageously be used for implementing a switch. For a switch, the shuttle Tn needs drive coils 4 (SLM) or drive magnets 3 (LLM) on both sides in normal direction z and a stator 2 on both sides in normal direction z of the shuttle Tn. The shuttle Tn would be moved between two stators 2. This is described for an LLM in EP 3 109 998 B1, which LLM could easily be adapted to also include a CPT arrangement 10 (the embodiment of FIG. 3 show secondary electrodes on both sides in normal direction z). Such a switch could however also be implemented with a SLM as shown in FIG. 2. To this end, the shuttle Tn were basically to be mirrored around the transverse direction y so that it comprised drive coils 4 and at least one secondary electrode 12 on both sides in normal direction z. On both sides in normal direction, a stator 2 were arranged. In the region of the switch, the stators 2 on both sides would diverge from each other in normal direction z.

The primary electrode 11 and the associated secondary electrode 12 forms a power transfer capacitor C_{PT}, with the power transfer air gap 13 as dielectric in between, that is used for capacitive power transfer for transferring electrical energy for energizing at least one of the number of drive coils 4 (SLM) or for energizing an electric component (SLM, LLM) on the shuttle Tn from the stator 2 to the shuttle Tn.

In some embodiments of the linear motor 1, there are provided two separate primary electrodes 11 on the stator 2 and two separate secondary electrodes 12 on the shuttle Tn. Each one of the primary electrodes 11 is coupled to one of the secondary electrodes 12 for forming a power transfer capacitor C_{PT}, with the power transfer air gap 13 as described above as dielectric in between, in each case.

In general, in capacitive power transfer, electric energy is transmitted by electric fields developing between the primary electrode 11 and secondary electrode 12 of a power transfer capacitor C_{PT}. To this end, an alternating (AC) primary voltage vₚ, provided by an AC power source 15, is applied to the primary electrode 11 causing an oscillating electric field that induces an AC secondary voltage vₛ on the secondary electrode 12 by electrostatic induction. This in turn causes an AC secondary current is to flow in an electric load 18 connected to the secondary electrode 12. The electric load 18 can be a drive coil 4, an electric component or an electric energy storage.

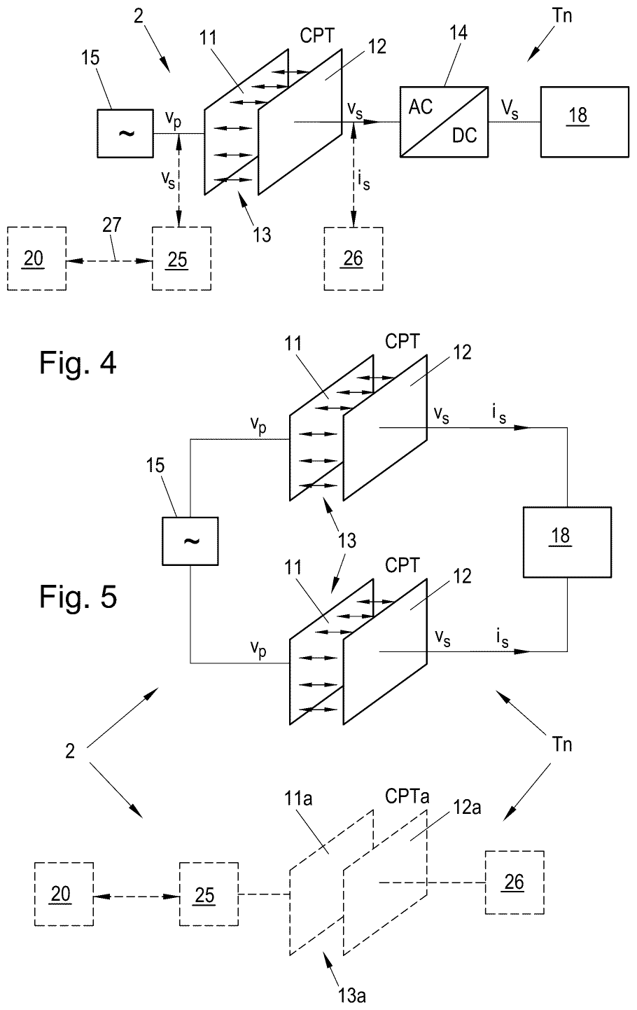

This well-known principle of capacitive power transfer is exemplarily shown in FIG. 4. In the embodiment of FIG. 4, an optional AC/DC-converter 14 is provided between the secondary electrode 12 and the load 18, for converting the AC secondary voltage vₛ and AC secondary current iₛ in a DC secondary voltage Vₛ and DC secondary current Iₛ.

FIG. 5 shows an embodiment of a CPT arrangement 10 using two power transfer capacitors C_{PT}. The AC power source 15 applies AC primary voltages vₚ with 180° phase difference to the primary electrodes 11. The generated electric fields in the power transfer capacitors C_{PT} induce opposite phase AC secondary voltages vₛ in the secondary electrodes 12, which in turn causes a secondary AC current iₛ to flow back and forth between the secondary electrodes 12 and through the load 18 connected thereto. Between load 18 and the secondary electrodes 12 a AC/DC-converter could be provided that would provide a DC secondary voltage Vₛ and DC secondary current Iₛ to load 18.

The amount of power transferred with the capacitive power transfer arrangement 10 increases with the frequency of the AC primary voltage vₚ and the capacitance of the power transfer capacitor C_{PT}, which is inversely proportional to the distance between the primary electrode 11 and secondary electrode 12 in normal direction z. This means that, the smaller the power transfer air gap distance T, the more electric power can be transferred for a given AC primary voltage vₚ.

The capacitive power transfer could be improved if resonant power transfer were used. In this case the power transfer capacitor C_{PT} could be integrated into an electric resonant circuit in that a choke (inductance) is connected in series or parallel to the secondary electrode 12. Also, the primary electrode 11 could be connected in series or parallel to a choke (inductance). The resonant circuit can also comprise additional passive electric components, like capacitors, inductances or resistor. By tuning the choke (value of the inductance) to the power transfer capacitor C_{PT}, the resonant circuit can be operated in or close to resonance. The resonant circuit can be excited to operate in resonance by adjusting the frequency of the AC primary voltage vₚ. The choke (inductance), and optional additional electrical components, can be arranged on a circuit board 22 (only shown in FIG. 2) provided on the shuttle Tn.

The transferred electric energy can also be stored in an electric energy storage 21 (only shown in FIG. 2) on the shuttle Tn, like a battery of a supercapacitor.

The electric energy transferred with CPT arrangement 10 in a SLM as linear motor 1 is primarily used on the shuttle Tn for energizing the number of drive coils 4 for driving the shuttle Tn. The electric energy could however additionally be used to power any other electric component on the shuttle Tn, like an actuator, a gripper, a pump or a device for data communication, on the shuttle Tn.

The CPT arrangement 10 could additionally also be used for data communication, also for bidirectional data communication, between the shuttle Tn and the motor control unit 20. This is exemplarily indicated in FIG. 4 The primary electrode 11 on the stator 2 is coupled to a first data communication unit 25. The first data communication unit 25 is connected to the motor control unit 20, via a data communication bus 27, for example. This first data communication unit 25 could superimpose an AC communication signal vₛ onto the AC primary voltage vₚ. Any possible modulation scheme, like frequency modulation or amplitude modulation, could be used with the AC communication signal vₛ for data communication. The used frequency ranges of the AC primary voltage vₚ and the AC communication signal vₛ are separated. At the secondary side, the AC communication signal vₛ, or a signal representative of the AC communication signal vₛ, is recovered (by demodulation or filtering, for example) from the AC secondary voltage vₛ by a second data communication unit 26 on the shuttle Tn. For bidirectional data communication, the communication would be the other direction, i.e., from the second data communication unit 26 to the first data communication unit 25.

It would however be possible to provide a separate primary electrode 11 and associated secondary electrode 12 only for data communication. In this case, power transfer and data communication were separated. For example, in FIG. 2 one of the primary electrode 11/secondary electrode 12 pair could be used for power transfer and the other for data communication. Or an additional primary electrode 11a on the stator 2 and an additional secondary electrode 12a on the shuttle Tn form an additional capacitor C_{PTa} used for data communication. This is exemplary indicating in FIG. 5. The additional primary electrode 11a were connected to a first data communication unit 25 and the additional secondary electrode 12a to a second data communication 26. The additional primary electrode 11a and additional secondary electrode 12a for data communication were however arranged as described above for power transfer, namely such the additional air gap 13a in between were parallel to the motor air gap 6 and separated from the motor air gap 6 (without overlap).

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. Linear motor having a stator and at least one shuttle movable along the stator in a direction of movement, wherein;
drive magnets are arranged along the stator in direction of movement and a number of drive coils are arranged on the at least one shuttle or drive magnets are arranged on the shuttle and a number of drive coils are arranged along the stator in direction of movement,
the drive magnets and the number of drive coils face each other and are separated in a normal direction by a motor air gap with a motor air gap distance in the normal direction,
the motor air gap extends in direction of movement and in a transverse direction that is normal on the direction of movement and the normal direction,
a capacitive power transfer arrangement is provided in the linear motor, the capacitive power transfer arrangement comprising at least one primary electrode arranged on the stator and extending in direction of movement and further comprising at least one secondary electrode arranged on the shuttle, the at least one secondary electrode facing the at least one primary electrode and being arranged in the normal direction opposite the at least one primary electrode,
the at least one primary electrode and the at least one secondary electrode are separated in the normal direction by a power transfer air gap with a power transfer air gap distance,
the power transfer air gap extends in direction of movement and in transverse direction,
the at least one primary electrode and the at least one secondary electrode form a power transfer capacitor with the power transfer air gap as dielectric for capacitive power transfer configured to transfer electrical energy from the stator to the shuttle, and
the motor air gap and the power transfer air gap are parallel and are arranged in transverse direction next to each other.

2. The linear motor according to claim 1, wherein:
at least one primary electrode is arranged in transverse direction on each side of the drive magnets or drive coils on the stator, in that at least one secondary electrode is arranged in transverse direction on each side of the drive coils or drive magnets on the shuttle, and
the at least one primary electrode on each side is coupled to the at least one secondary electrode on each side to form in each case a power transfer capacitor.

3. The linear motor according to claim 1, wherein:
two primary electrodes are arranged in transverse direction on one side of the drive magnets or drive coils on the stator,
two secondary electrodes are arranged in transverse direction on the same side than the primary electrodes, and
each one of the primary electrodes is coupled to one of the secondary electrodes to form in each case a power transfer capacitor.

4. The linear motor according to claim 2, wherein both power transfer capacitors are used in the capacitive power transfer arrangement for capacitive power transfer.

5. The linear motor according to claim 2, wherein a first one of the power transfer capacitors is used for capacitive power transfer and a second one of the power transfer capacitors is used for capacitive data communication between a first data communication unit connected to the primary electrode of second power transfer capacitor and a second data communication unit connected to the secondary electrode of the second power transfer capacitor.

6. The linear motor according to claim 1, wherein an additional primary electrode is arranged on the stator of the linear motor and an additional secondary electrode is arranged on the at least one shuttle of the linear motor, the additional primary electrode and additional secondary electrode forming an additional power transfer capacitor that is configured to provide capacitive data communication between a first data communication unit connected to the additional primary electrode of the additional power transfer capacitor and a second data communication unit connected to the additional secondary electrode of the additional power transfer capacitor.

7. The linear motor according to claim 6, wherein:
the additional secondary electrode faces the additional primary electrode and is arranged in the normal direction opposite the additional primary electrode,
the additional primary electrode and the additional secondary electrode are separated by an additional air gap with an additional air gap distance in the normal direction,
the additional air gap extends in direction of movement and in transverse direction,
the additional primary electrode and the additional secondary electrode form the additional capacitor with the additional air gap as dielectric, and
the motor air gap and the additional air gap are parallel and are arranged in transverse direction next to each other.

8. The linear motor according to claim 1, wherein the power transfer capacitor formed by at least one primary electrode and the associated at least one secondary electrode is additionally configured to provide capacitive power transfer between a first data communication unit connected to the at least one primary electrode of the power transfer capacitor and a second data communication unit connected to the at least one secondary electrode of the power transfer capacitor.

9. The linear motor according to claim 1, wherein the capacitive power transfer arrangement is provided in the normal direction on both sides of the at least one shuttle and with a stator provided in the normal direction on both sides of the at least one shuttle.

10. The linear motor according to claim 1, wherein the stator comprises at least one bend in which the stator is bent around the normal direction.

11. The linear motor according to claim 1, wherein the stator comprises at least one bend in which the stator is bent around the transverse direction.

12. The linear motor according to claim 3, wherein both power transfer capacitors are used in the capacitive power transfer arrangement for capacitive power transfer.

13. The linear motor according to claim 3, wherein a first one of the power transfer capacitors is used for capacitive power transfer and a second one of the power transfer capacitors is used for capacitive data communication between a first data communication unit connected to the primary electrode of second power transfer capacitor and a second data communication unit connected to the secondary electrode of the second power transfer capacitor.

14. The linear motor according to claim 2, wherein an additional primary electrode is arranged on the stator of the linear motor and an additional secondary electrode is arranged on the at least one shuttle of the linear motor, the additional primary electrode and additional secondary electrode forming an additional power transfer capacitor that is configured to provide capacitive data communication between a first data communication unit connected to the additional primary electrode of the additional power transfer capacitor and a second data communication unit connected to the additional secondary electrode of the additional power transfer capacitor.

15. The linear motor according to claim 14, wherein:
the additional secondary electrode faces the additional primary electrode and is arranged in the normal direction opposite the additional primary electrode,
the additional primary electrode and the additional secondary electrode are separated by an additional air gap with an additional air gap distance in the normal direction,
the additional air gap extends in direction of movement and in transverse direction,
the additional primary electrode and the additional secondary electrode form the additional capacitor with the additional air gap as dielectric, and
the motor air gap and the additional air gap are parallel and are arranged in transverse direction next to each other.

16. The linear motor according to claim 15, wherein the capacitive power transfer arrangement is provided in the normal direction on both sides of the at least one shuttle and with a stator provided in the normal direction on both sides of the at least one shuttle.

17. The linear motor according to claim 16, wherein the stator comprises at least one bend in which the stator is bent around the normal direction.

18. The linear motor according to claim 3, wherein an additional primary electrode is arranged on the stator of the linear motor and an additional secondary electrode is arranged on the at least one shuttle of the linear motor, the additional primary electrode and additional secondary electrode forming an additional power transfer capacitor that is configured to provide capacitive data communication between a first data communication unit connected to the additional primary electrode of the additional power transfer capacitor and a second data communication unit connected to the additional secondary electrode of the additional power transfer capacitor.

19. The linear motor according to claim 18, wherein:
the additional secondary electrode faces the additional primary electrode and is arranged in the normal direction opposite the additional primary electrode,
the additional primary electrode and the additional secondary electrode are separated by an additional air gap with an additional air gap distance in the normal direction,
the additional air gap extends in direction of movement and in transverse direction,
the additional primary electrode and the additional secondary electrode form the additional capacitor with the additional air gap as dielectric, and
the motor air gap and the additional air gap are parallel and are arranged in transverse direction next to each other.

20. The linear motor according to claim 19, wherein the capacitive power transfer arrangement is provided in the normal direction on both sides of the at least one shuttle and with a stator provided in the normal direction on both sides of the at least one shuttle, and wherein the stator comprises at least one bend in which the stator is bent around the normal direction.
